(19) United States
(12) Patent Application Publication
(10) Pub. No.: US 2009/0290567 A1
(43) Pub. Date: Nov. 26, 2009

(54) WIRELESS COMMUNICATION PERFORMING WIRELESS LAN COMMUNICATION

(76) Inventor: Kiyotaka MATSUE, Yokohama-shi (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/471,979

(22) Filed: May 26, 2009

(30) Foreign Application Priority Data
May 26, 2008 (JP) 2008-137172

(51) Int. Cl. H04W 40/00

(52) U.S. Cl. 370/338

(57) ABSTRACT

A local station of an example of the invention performing TCP/IP communication conforming to a IEEE 802.11 standard comprises an unit for receiving a WLANDATA frame formed by encapsulating a TCPDATA segment from a center station, an unit for transmitting a WLANACK frame which is delivery confirmation information corresponding to the WLANDATA frame to the local station, and an unit for executing processing of stopping transmission of a TCPACK segment which is delivery confirmation information corresponding to the TCPDATA segment when the WLANACK frame is transmitted to the center station.

### CROSS-REFERENCE TO RELATED APPLICATIONS

This application is based upon and claims the benefit of priority from prior Japanese Patent Application No. 2008-137172, filed May 26, 2008, the entire contents of which are incorporated herein by reference.

### BACKGROUND OF THE INVENTION

1. Field of the Invention

The present invention relates to a wireless communication device complying with IEEE 802.11 standards, which are standards for wireless local area network (LAN) communication such as IEEE 802.11, IEEE 802.11e, IEEE 802.11n, and the like, and performing TCP/IP communication.

2. Description of the Related Art

As the standards for wireless LAN communication, there are various IEEE 802.11 standards such as IEEE 802.11, IEEE 802.11e, IEEE 802.11n, and the like. In wireless LAN communication conforming to the IEEE 802.11 standards, data transmission is performed in a communication method based on a frame format provided by the IEEE 802.11 standards, and communication control protocol.

In a wireless LAN communication standard, a function of performing data delivery confirmation with respect to a transmission destination is included.

In an environment of wireless LAN communication conforming to the IEEE 802.11 standards, when TCP/IP communication is carried out between a communication device (access point) of a center station and a communication device (station) of a local station, in order to confirm delivery of a TCPDATA segment which is a transmission object (target), it is necessary to perform transmission/reception processing of a TCPACK segment which is delivery confirmation information for the TCPDATA segment.

However, the delivery confirmation processing is performed at the level of the wireless LAN communication in addition to the TCP/IP communication level. For this reason, in the prior art, the similar processing for delivery confirmation is performed twice, which is duplicate.

In Pat. Document 1 (Jpn. Pat. Appln. KOKAI Publication No. 2006-217242), an invention which realizes efficient transmission in wireless LAN communication conforming to IEEE 802.11 by preparing and analyzing a Block Ack frame from which the Block Ack Bitmap field is removed is described.

### BRIEF SUMMARY OF THE INVENTION

In a first example of this invention, a wireless communication device of a local station performing TCP/IP communication in an environment in which wireless LAN communication conforming to a IEEE 802.11 standard is performed comprises: a transmission processing unit for transmitting a WLANACK frame which is delivery confirmation information corresponding to the WLANDATA frame to the wireless communication device of the local station; and a TCPACK transmission stop unit for executing processing of stopping transmission of a TCPACK segment which is delivery confirmation information corresponding to the TCPDATA segment when the WLANACK frame is transmitted to the wireless communication device of the center station.

In a second example of this invention, a wireless communication device of a local station performing TCP/IP communication in an environment in which wireless LAN communication conforming to a IEEE 802.11e or IEEE 802.11n standard is performed comprises: a reception processing unit for receiving a BlockACK Request frame for requesting a BlockACK frame which is delivery confirmation information corresponding to a plurality of WLANDATA frames each of which is formed by encapsulating a TCPDATA segment from a wireless communication device of a center station; a transmission processing unit for transmitting, when the BlockACK Request frame is received, the BlockACK frame to the wireless communication device of the center station; and a TCPACK transmission stop unit for executing processing of stopping transmission of a TCPACK segment which is delivery confirmation information corresponding to a TCPDATA segment encapsulated in a normally received WLANDATA frame among the plurality of WLANDATA frames when the BlockACK frame is transmitted to the wireless communication device of the center station.

### BRIEF DESCRIPTION OF THE SEVERAL VIEWS OF THE DRAWING

FIG. 1 is a system configuration view showing an example of a communication system according to a first embodiment of this invention;

FIG. 2 is a block diagram showing an example of a hardware configuration of a communication device according to the first embodiment;

FIG. 3 is a block diagram showing an example of software of a communication device of a center station according to the first embodiment;

FIG. 4 is a block diagram showing an example of software of a communication device of a local station according to the first embodiment;

FIG. 5 is a sequence diagram exemplifying communication performed in a conventional communication system, and communication performed in the communication system according to the first embodiment;

FIG. 6 is a flowchart showing an example of processing of the communication device of the center station according to the first embodiment;

FIG. 7 is a flowchart showing an example of processing of the communication device of the local station according to the first embodiment;

FIG. 8 is a sequence diagram exemplifying communication performed in a conventional communication system, and communication performed in a communication system according to a second embodiment of this invention;

FIG. 9 is a sequence diagram showing an example of communication performed in a communication system according to a fourth embodiment of this invention;

FIG. 10 is a sequence diagram showing an example of communication performed in a communication system according to a fifth embodiment of this invention; and

FIG. 11 is a block diagram showing an example of software of a communication device of a local station according to the sixth embodiment of this invention.

### DETAILED DESCRIPTION OF THE INVENTION

Embodiments of the present invention will be described below with reference to the accompanying drawings. It should be noted that in the following drawings, the same parts are denoted by the same reference symbols and description of them will be omitted.

### First Embodiment

A wireless communication device according to this embodiment performs a wireless LAN communication conforming to IEEE 802.11 standards, and TCP/IP communication. As a TCP protocol, many protocols are proposed on the basis of RFC793. In this embodiment, for example, RFC793 can be used as the TCP protocol. However, other protocols may also be used.

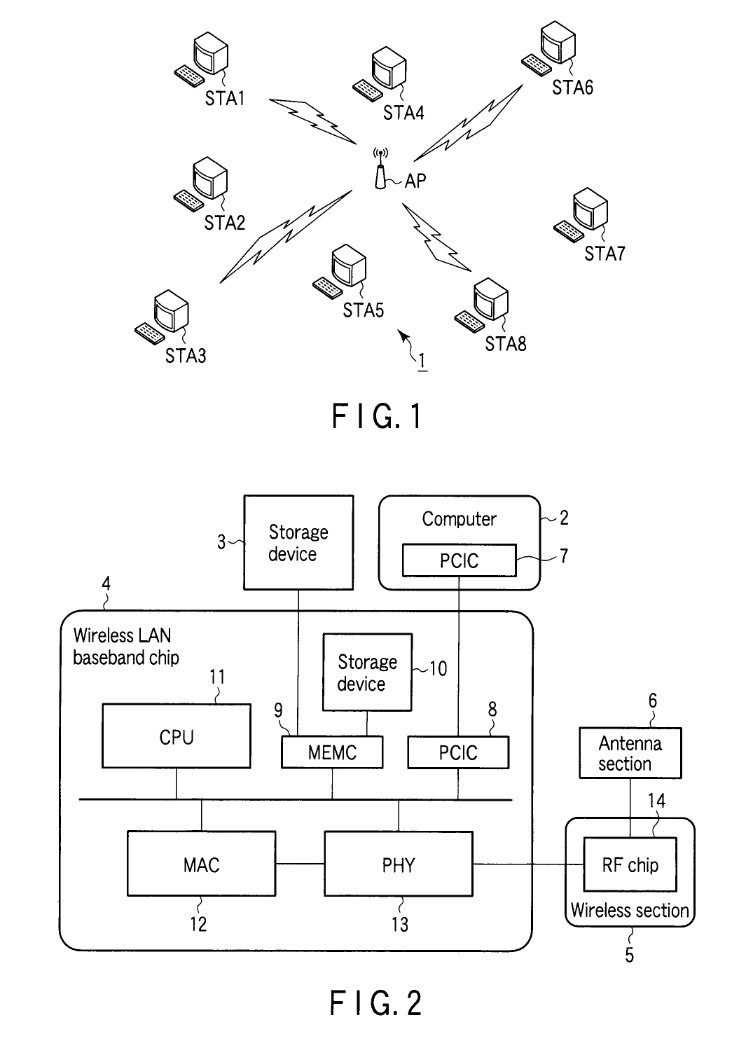

FIG. 1 is a system configuration view showing an example of a communication system according to this embodiment.

A communication system 1 is a wireless LAN communication system. In the communication system 1, wireless LAN communication conforming to the IEEE 802.11 standards, and TCP/IP communication conforming to RFC793 are enabled.

A communication device (Access Point : data transmission side) AP of a center station can communicate with one or more communication devices (Station : data reception side) STA1 to STA8 of local stations. It should be noted that the number of the communication devices of the local stations can be freely changed.

When wireless LAN communication conforming to the IEEE 802.11 standards is to be performed, in the communication system 1, a WLANDATA frame is transmitted from the communication device AP of the center station to the communication device STA1 to STA8 of the local stations, and a WLANACK frame which is delivery confirmation information is transmitted from each of the communication device STA1 to STA8 of the local stations that have received the WLANDATA frame to the communication device AP of the center station.

Further, also when TCP/IP communication is to be performed between two terminals, i.e., the communication device AP of the center station and one of the communication devices STA1 to STA8 (in this case, the communication device STA1 of the local station) of the local stations, as in the case of the wireless LAN communication, a TCPDATA segment is transmitted from the communication device AP of the center station to the communication device STA1 of the local station, and a TCPACK segment which is delivery confirmation information is transmitted from the communication device STA1 of the local station that has received the TCPDATA segment to the communication device AP of the center station.

Normally, when TCP/IP communication is performed on the wireless LAN communication, both the WLANACK frame which is the delivery confirmation information in the wireless LAN communication, and the TCPACK segment which is the delivery confirmation information in the TCP/IP communication are transmitted from the communication device STA1 of the local station to the communication device AP of the center station.

However, in this embodiment, when the TCP/IP communication is performed on the wireless LAN communication, the WLANACK frame which is the delivery confirmation information in the wireless LAN communication, and the TCPACK segment which is the delivery confirmation information in the TCP/IP communication are put together.

In this embodiment, when the TCP/IP communication is performed on the wireless LAN communication, transmission of the TCPACK segment for delivery confirmation to be transmitted from the communication device STA1 to STA8 of the local stations to the communication device AP of the center station is omitted, and the WLANACK frame for delivery confirmation is transmitted from each of the communication device STA1 to STA8 of the local stations to the communication device AP of the center station, whereby the communication device AP of the center station performs delivery confirmation of the TCP/IP communication in addition to that of the wireless LAN communication.

FIG. 2 is a block diagram showing an example of a hardware configuration of the communication device AP, and STA1 to STA8 according to this embodiment.

The communication device AP of the center station according to this embodiment is provided with a computer 2, storage device 3 such as an SDRAM or the like, wireless LAN baseband chip 4, wireless section 5, and antenna section 6.

In the communication device AP of the center station, the computer 2 transmits data to be transmitted from a Peripheral Component Interconnect controller (PCIC) 7 on the computer 2 side to a PCIC 8 on the wireless LAN baseband chip 4 side, and memory controller (MEMC) 9 in the order mentioned, and the transmitted data is stored in a storage device 10 or storage device 3 such as an SRAM or the like. As described above, access to the storage device 3 or 10 is performed by using the MEMC 9.

A CPU 11 accesses the data stored in the storage device 3 or storage device 10 through the MEMC 9, executes processing for data transmission, and outputs data obtained after the processing to the wireless section 5 through a medium access controller (MAC) 12, and physical layer (PHY) 13.

Further, the data obtained after the processing is delivered from an RF chip 14 of the wireless section 5 to an antenna section 6, and is transmitted as a frame of the wireless LAN communication.

It should be noted that in the case of the communication device STA1 to STA8 of the local stations, an operation opposite to the operation of the communication device AP is performed.

Various functions performed by the communication device according to this embodiment can be realized by both software and hardware. When the functions are realized by hardware, the functions can be realized by, for example, the MAC 12. When the functions are realized by software, the functions can be realized by, for example, the CPU 11.

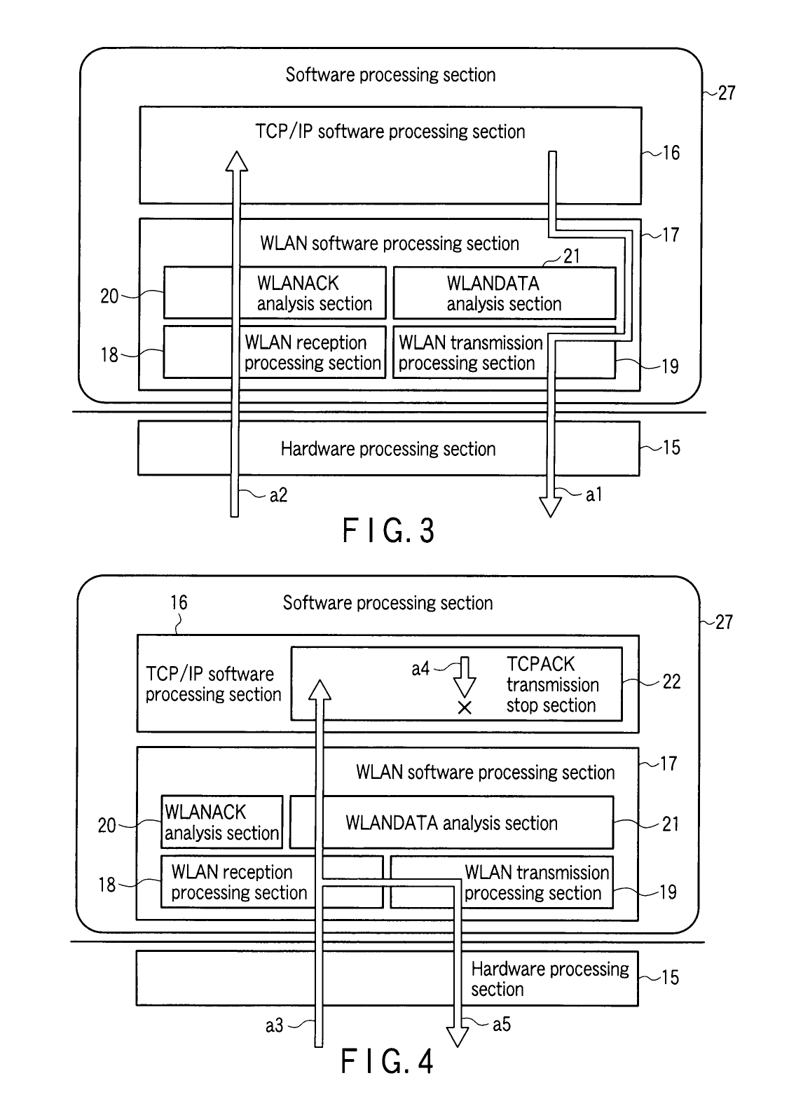

FIG. 3 is a block diagram showing an example of software of the communication device AP of the center station according to this embodiment. In FIG. 3, an arrow a1 indicates a flow of data from a software processing section 27 to a hardware processing section 15 in a case where a WLANDATA frame is transmitted. An arrow a2 indicates a flow of data from the hardware processing section 15 to the software processing section 27 in a case where a WLANACK frame which is delivery confirmation for the WLANDATA frame is received.

In the communication device AP, the software processing section 27 and hardware processing section 15 cooperate with each other to realize communication processing. The software processing section 27 is provided with a TCP/IP software processing section 16 and WLAN software processing section 17.

Further, the WLAN software processing section 17 is provided with a WLAN reception processing section 18, WLAN transmission processing section 19, WLANACK analysis section 20, and WLANDATA analysis section 21. It should be noted that the WLAN reception processing section 18 and WLAN transmission processing section 19 may be combined with each other to form a WLAN transmission/reception processing section.

The TCP/IP software processing section 16 creates a TCPDATA segment on the basis of data created by a host application program.

The TCP/IP software processing section 16 delivers the TCPDATA segment to the WLAN transmission processing section 19 of the WLAN software processing section 17.

The WLAN transmission processing section 19 creates a WLANDATA frame on the basis of the TCPDATA segment received from the TCP/IP software processing section 16. More specifically, the WLAN transmission processing section 19 executes processing of mapping the TCPDATA segment onto the WLANDATA frame to create a WLANDATA frame formed by encapsulating the TCPDATA segment.

The created WLANDATA frame is transmitted through the wireless section 5 or the like of the hardware processing section 15.

When the TCPDATA segment is transmitted as the WLANDATA frame, and the WLANDATA frame is normally received by the communication terminals STA1 to STA8 of the local stations, each of the communication terminals STA1 to STA8 of the local stations transmits a WLANACK frame to the communication terminal AP of the center station.

The communication device AP of the center station receives the WLANACK frame from each of the communication terminals STA1 to STA8 of the local stations at the hardware processing section 15.

The hardware processing section 15 delivers the received WLANACK frame to the WLANACK analysis section 20 through the WLAN reception processing section 18.

The WLANACK analysis section 20 retrieves a TCPDATA segment corresponding to the WLANACK frame on the basis of the WLANACK frame, creates a TCPACK segment indicative of delivery confirmation of the retrieved TCPDATA segment, and delivers the TCPACK segment to the TCP/IP software processing section 16. That is, the WLANACK analysis section 20 utilizes data indicative of a WLANDATA frame onto which the TCPDATA segment before the transmission is mapped to recognize/determine the WLANDATA frame corresponding to the delivery confirmation indicated by the received WLANACK frame, and recognizes/determines the TCPDATA segment corresponding to the delivery confirmation indicated by the received WLANACK frame from the above recognition/determination result.

Upon receipt of the TCPACK segment created on the basis of the received WLANACK frame, the TCP/IP software processing section 16 performs the same processing as that performed when a TCPACK segment is received.

FIG. 4 is a block diagram showing an example of software of the communication devices STA1 to STA8 of the local stations according to this embodiment. In FIG. 4, an arrow a3 expresses a flow of the received WLANDATA frame and the TCPDATA segment encapsulated in the WLANDATA frame. An arrow a4 expresses a flow of the TCPACK segment. An arrow a5 expresses a flow of the WLANACK frame.

The WLAN reception processing section 18 of the software processing section 27 receives the WLANDATA frame through the hardware processing section 15. The WLAN transmission processing section 19 transmits a WLANACK frame corresponding to the received WLANDATA frame to the communication device AP of the center station through the hardware processing section 15.

Further, the WLANDATA analysis section 21 of the software processing section 27 receives the WLANDATA frame from the WLAN reception processing section 18, performs analysis of the inside of the WLANDATA frame, and delivers information indicating that the WLANACK frame corresponding to the WLANDATA frame has already been transmitted to the communication device AP of the center station to the TCP/IP software processing section 16.

When the TCPDATA segment is included in the WLANDATA frame, the WLANDATA frame including the TCPDATA segment is delivered from the WLAN software processing section 17 to the TCP/IP software processing section 16.

The TCP/IP software processing section 16 receives the TCPDATA segment from the WLAN software processing section 17.

Upon receipt of the TCPDATA segment, a TCPACK transmission stop section 22 of the TCP/IP software processing section 16 determines whether or not information indicating that the WLANACK frame corresponding to the WLANDATA frame that has encapsulated the TCPDATA segment has already been transmitted has already been received.

If the information indicating that the WLANACK frame has already been transmitted has already been received, the TCPACK transmission stop section 22 stops the processing for transmitting the TCPACK segment to the communication device AP of the center station. On the other hand, if the information indicating that the WLANACK frame has already been transmitted has not been received yet, the TCP/IP software processing section 16 performs processing for transmitting the TCPACK segment to the communication device AP of the center station.

Although in the case of the ordinary TCP/IP software processing section, the TCPACK segment corresponding to the received TCP segment is created/transmitted, the TCP/IP software processing section 16 according to this embodiment includes a function of stopping the processing of creating or transmitting a TCPACK segment.

An operation example of the communication system 1 according to this embodiment having the configuration described above will be described below.

As described above, each of the communication devices AP, and STA1 to STA8 according to this embodiment is provided with a WLAN reception processing section 18, WLAN transmission processing section 19, WLANACK analysis section 20, WLANDATA analysis section 21, and TCPACK transmission stop section 22 for substituting transmission/reception of a WLANACK frame for transmission/reception of a TCPACK segment.

First, the communication system 1 completes wireless connection (completes association processing) between the communication device AP of the center station and the communication devices STA1 to STA8 of the local stations. In this state, wireless LAN communication is enabled.

Then, the communication system 1 establishes TCP connection for executing TCP/IP communication. When the TCP connection is established, the TCP communication is enabled.

The communication device AP of the center station executes transmission processing of the TCPDATA segment by the normal method. The communication device AP of the center station performs transmission by wireless LAN communication, and hence the TCPDATA segment is encapsulated in the wireless LAN communication frame to be transmitted.

When a WLANDATA frame including the TCPDATA segment is received, the communication devices STA1 to STA8 of the local stations transmit a WLANACK frame which is delivery confirmation information for the WLANDATA frame. Furthermore, when the WLANDATA frame including the TCPDATA segment is received, the communication devices STA1 to STA8 of the local stations execute the processing of stopping the transmission of the TCPACK segment.

That is, normally, when the wireless LAN communication frame including the TCPDATA segment is received, a delivery confirmation frame for the wireless LAN communication frame is transmitted, and thereafter the transmission processing of the delivery confirmation segment for the TCPDATA segment is executed in the TCP layer as the need arises. However, in this embodiment, the transmission processing of the delivery confirmation segment for the TCPDATA segment is intentionally stopped.

When the WLANACK frame which is delivery confirmation information for the WLANDATA frame including the TCPDATA segment is received, the communication device AP of the center station notifies the TCP layer of information indicating that delivery confirmation has been performed by the WLANACK frame. For example, in the case where the wireless environment is worsened, when at least one of the communication devices STA1 to STA8 of the local stations cannot normally receive the WLANDATA frame, i.e., the TCPDATA segment, and the WLANACK frame is not transmitted to the communication device of the center station, it is possible to make the processing to be performed thereafter by the communication device AP of the center station and the communication devices STA1 to STA8 of the local stations identical with the processing by the existing technique.

Further, it is also possible to make the processing of the case where even though the communication devices STA1 to STA8 of the local stations normally transmit a WLANACK frame to the communication device AP of the center station, the communication device AP of the center station cannot receive the WLANACK frame identical with the processing by the existing technique.

The conventional communication sequence and the communication sequence according to this embodiment will be described below.

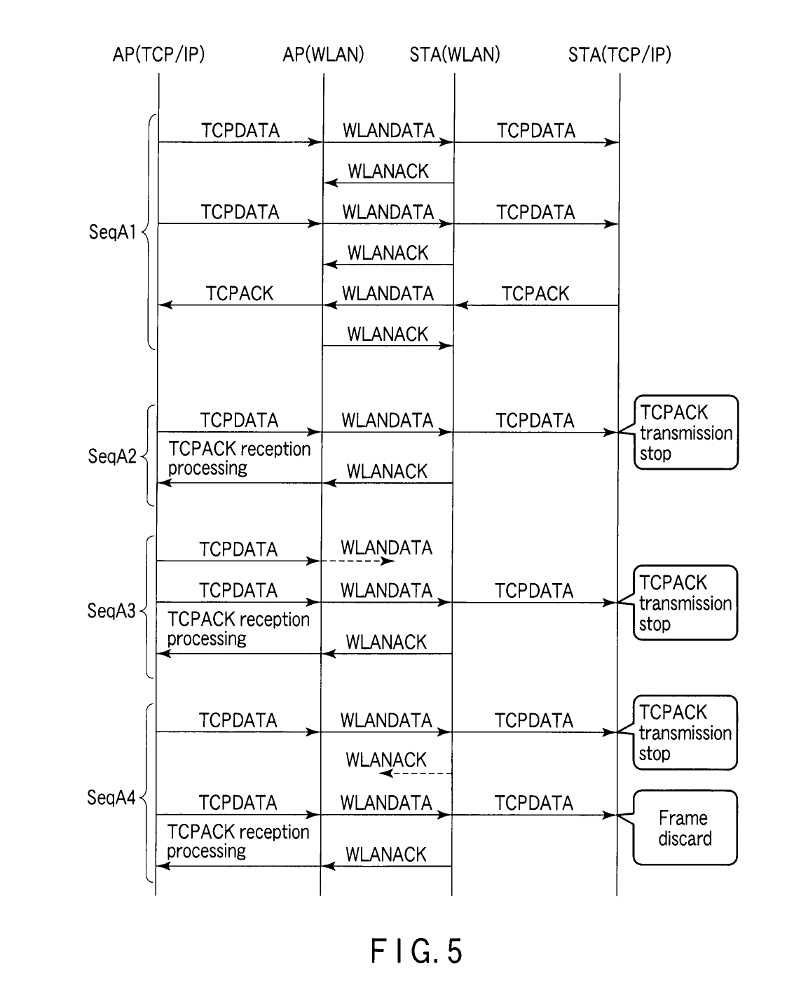

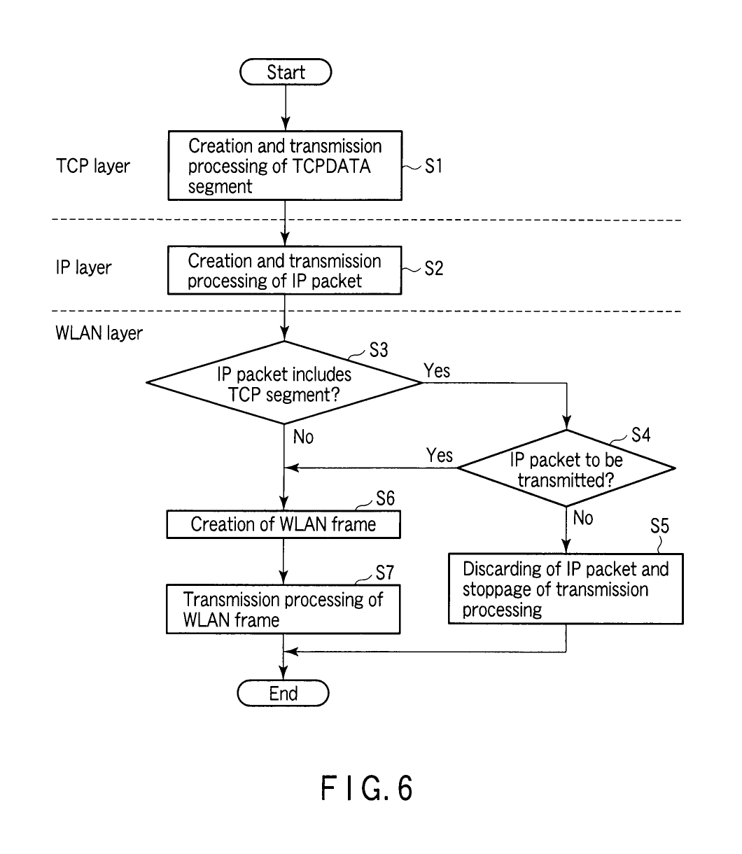

FIG. 5 is a sequence diagram (NormalACK) exemplifying the communication performed in the conventional communication system, and the communication performed in the communication system according to this embodiment.

The AP (TCP/IP) and AP (WLAN) are each processing to be performed in the same communication device AP. The AP (TCP/IP) is processing for TCP/IP communication in the communication device AP of the center station. The AP (WLAN) is processing for wireless LAN communication in the communication device AP of the center station.

Likewise, the STA (WLAN) and STA (TCP/IP) are each processing to be performed in the same communication devices STA1 to STA8. The STA (WLAN) is processing for wireless LAN communication in the communication devices STA1 to STA8 of the local stations. The STA (TCP/IP) is processing for TCP/IP communication in the communication devices STA1 to STA8 of the local stations.

Sequence SeqA1 denotes data communication of the existing technique.

First, the AP (TCP/IP) gives a TCPDATA segment to the AP (WLAN). The AP (WLAN) transmits a WLANDATA frame formed by encapsulating the TCPDATA segment to the STA (WLAN).

The STA (WLAN) receives the WLANDATA frame, and gives the TCPDATA segment included in the WLANDATA frame to the STA (TCP/IP), and transmits a WLANACK frame corresponding to the received WLANDATA frame to the AP (WLAN).

It should be noted that in this sequence SeqA1, when two TCPDATA segments are received, the STA (TCP/IP) gives the TCPACK segment which is a delivery confirmation segment corresponding to the received TCPDATA segment to the STA (WLAN). The STA (WLAN) transmits the WLANDATA frame formed by encapsulating the TCPACK segment to the AP (WLAN).

The AP (WLAN) receives the WLANDATA frame, gives the TCPACK segment included in the WLANDATA frame to the AP (TCP/IP), and transmits a WLANACK frame corresponding to the received WLANDATA frame to the STA (WLAN).

Sequence SeqA2 denotes data communication of a case where no frame loss occurs in the wireless communication in the communication system 1 according to this embodiment.

In sequence SeqA2 in which no frame loss occurs, first, the AP (TCP/IP) gives the TCPDATA segment to the AP (WLAN). The AP (WLAN) transmits a WLANDATA frame formed by encapsulating the TCPDATA segment to the STA (WLAN).

The STA (WLAN) receives the WLANDATA frame, and gives the TCPDATA segment included in the WLANDATA frame to the STA (TCP/IP).

Although the STA (TCP/IP) receives the TCPDATA segment, the STA (TCP/IP) stops the processing of giving a TCPACK segment corresponding to the TCPDATA segment to the STA (WLAN).

The STA (WLAN) transmits a WLANACK frame corresponding to the received WLANDATA frame to the AP (WLAN).

The AP (WLAN) determines whether or not the WLANACK frame can be received, creates a TCPACK segment on condition that the WLANACK frame is received, and gives the created TCPACK segment to the AP (TCP/IP).

Sequence SeqA3 denotes data communication of a case where loss occurs in the WLANDATA frame in the wireless communication in the communication system 1 according to this embodiment.

In sequence SeqA3, first, the AP (TCP/IP) gives a TCPDATA segment to the AP (WLAN). Although the AP (WLAN) transmits a WLANDATA frame formed by encapsulating the TCPDATA segment to the STA (WLAN), frame loss occurs midway, and the STA (WLAN) does not normally receive the WLANDATA frame.

The STA (WLAN) receives no WLANDATA frame, and hence the STA (WLAN) neither gives a TCPDATA segment to the STA (TCP/IP), nor transmits a WLANACK frame corresponding to the WLANDATA frame received by the STA (WLAN) to the AP (WLAN). For this reason, the AP (WLAN) side does not receive the WLANACK frame.

Then, the AP (TCP/IP) again gives the TCPDATA segment to the AP (WLAN), and the AP (WLAN) again transmits the WLANDATA frame formed by encapsulating the TCPDATA segment to the STA (WLAN).

By the retransmission of the WLANDATA frame, the STA (WLAN) receives the WLANDATA frame.

Then, the STA (WLAN) gives the TCPDATA segment included in the WLANDATA frame to the STA (TCP/IP). Although the STA (TCP/IP) receives the TCPDATA segment, the STA (TCP/IP) stops the processing of giving the TCPACK segment corresponding to the TCPDATA segment to the STA (WLAN).

The STA (WLAN) transmits a WLANACK frame corresponding to the received WLANDATA frame to the AP (WLAN). The AP (WLAN) determines whether or not the WLANACK frame has been received, creates a TCPACK segment on condition that the WLANACK frame is received, and gives the created TCPACK segment to the AP (TCP/IP).

Sequence SeqA4 denotes data communication of a case where loss occurs in the WLANACK frame in the wireless communication in the communication system 1 according to this embodiment.

In sequence SeqA4, first, the AP (TCP/IP) gives a TCPDATA segment to the AP (WLAN). The AP (WLAN) transmits a WLANDATA frame formed by encapsulating the TCPDATA segment to the STA (WLAN).

The STA (WLAN) receives the WLANDATA frame, and gives the TCPDATA segment included in the WLANDATA frame to the STA (TCP/IP).

Although the STA (TCP/IP) receives the TCPDATA segment, the STA (TCP/IP) stops the processing of giving a TCPACK segment corresponding to the TCPDATA segment to the STA (WLAN).

Although the STA (WLAN) transmits a WLANACK frame corresponding to the received WLANDATA frame to the AP (WLAN), frame loss occurs midway, and the AP (WLAN) does not normally receive the WLANACK frame.

In the wireless LAN communication, even when the WLANDATA frame is received by the STA (WLAN), if the WLANACK frame which is the delivery confirmation information of the WLANDATA frame is not received, the AP (TCP/IP) again gives the TCPDATA segment to the AP (WLAN), and the AP (WLAN) again transmits a WLANDATA frame formed by encapsulating the TCPDATA segment to the STA (WLAN).

The STA (WLAN) retransmits the WLANDATA frame, and gives the TCPDATA segment included in the retransmitted WLANDATA frame to the STA (TCP/IP).

The STA (TCP/IP) receives, in addition to the TCPDATA segment transmitted previously, the same TCPDATA segment obtained by the retransmission. However, when the same segment is received, one of them is discarded. Even in this case, the STA (TCP/IP) stops the processing of giving a TCPACK segment corresponding to the TCPDATA segment to the STA (WLAN).

The STA (WLAN) transmits the second WLANACK frame corresponding to the received second WLADATA frame to the AP (WLAN). The AP (WLAN) determines whether or not the WLANACK frame has been received, creates a TCPACK segment on condition that the WLANACK frame is received, and gives the created TCPACK segment to the AP (TCP/IP).

FIG. 6 is a flowchart showing an example of transmission processing of the WLAN frame of the communication device AP of the center station according to this embodiment.

In step S1, the communication device AP of the center station creates a TCPDATA segment, and executes management of the sequence number and the transmission processing.

In step S2, the communication device AP of the center station creates an IP packet, and executes the transmission processing.

In step S3, the communication device AP of the center station performs first determination processing of determining whether or not the IP packet includes the TCPACK segment.

When the result of the first determination processing indicates that the IP packet does not include the TCPACK segment, the processing proceeds to step S6.

When the result of the first determination processing indicates that the IP packet includes the TCPACK segment, in step S4, the communication device AP of the center station performs second determination processing of determining whether or not the IP packet is an IP packet to be transmitted.

When the result of the second determination processing indicates that the IP packet is an IP packet to be transmitted, the processing proceeds to step S6.

When the result of the second determination processing indicates that the IP packet is an IP packet not to be transmitted, in step S5, the communication device AP of the center station executes discarding of the packet and processing of stopping transmission, and thereafter the processing is terminated.

In step S6, the communication device AP of the center station performs management of the TCP sequence number with respect to the IP packet to be transmitted, and creates a WLAN frame.

In step S7, the communication device AP of the center station executes transmission processing of the created WLAN frame.

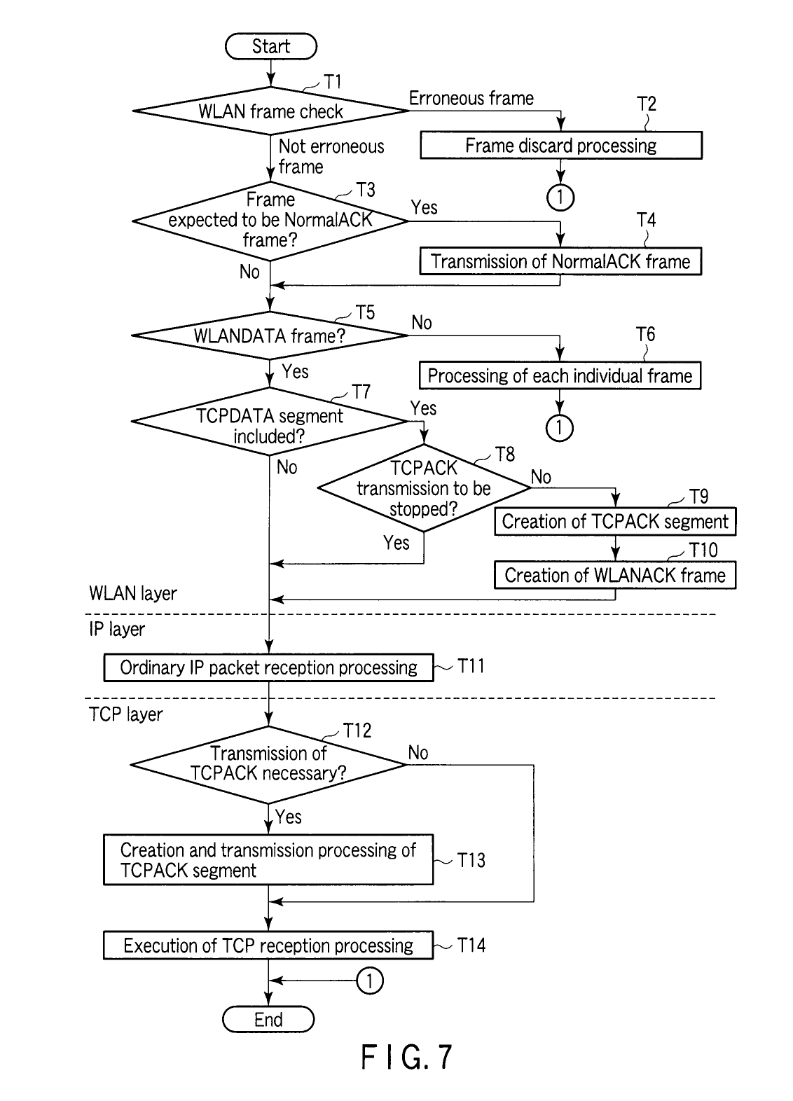

FIG. 7 is a flowchart showing an example of processing of the communication devices STA1 to STA8 of the local stations according to this embodiment.

In step T1, each of the communication devices STA1 to STA8 of the local stations according to this embodiment executes first check processing of checking whether or not the received WLAN frame is an erroneous frame (for example, CRC check and the like).

When the result of the first check processing indicates that the received WLAN frame is an erroneous frame, each of the communication devices STA1 to STA8 of the local stations executes in step T2 frame discard processing, and thereafter the processing is terminated.

When the result of the first check processing indicates that the received WLAN frame is not an erroneous frame, each of the communication devices STA1 to STA8 of the local stations executes in step T3 second check processing of checking whether or not the received WLAN frame is a frame expected to be a NormalACK frame.

When the result of the second check processing indicates that the received WLAN frame is a frame expected to be the NormalACK frame, each of the communication devices STA1 to STA8 of the local stations performs in step T4 transmission of the NormalACK frame, and then the processing proceeds to step T5.

When the result of the second check processing indicates that the received WLAN frame is not a frame expected to be the NormalACK frame, the processing proceeds to step T5.

In step T5, each of the communication devices STA1 to STA8 of the local stations executes third check processing of checking whether or not the received WLAN frame is a WLANDATA frame (checking the type of the received WLAN frame; a data-oriented frame, control-oriented frame or management-oriented frame).

When the result of the third check processing indicates that the received WLAN frame is not a WLANDATA frame, each of the communication devices STA1 to STA8 of the local stations executes in step T6 processing of each individual frame, and thereafter the processing is terminated.

When the result of the third check processing indicates that the received WLAN frame is a WLANDATA frame, each of the communication devices STA1 to STA8 of the local stations executes in step T7 fourth check processing of checking whether or not the WLANDATA frame includes a TCPDATA segment. Here, if the result of the fourth check processing indicates that the WLANDATA frame does not include a TCPDATA segment, the processing proceeds to step T11.

If the result of the fourth check processing indicates that the WLANDATA frame includes a TCPDATA segment, each of the communication devices STA1 to STA8 of the local stations executes in step T8 fifth check processing of checking whether or not TCPACK transmission is to be stopped (whether or not the TCPACK segment creation processing is to be executed).

When the result of the fifth check processing indicates that the TCPACK transmission is to be stopped (the TCPACK segment is not to be created), the processing proceeds to step T11.

When the result of the fifth check processing indicates that the TCPACK transmission is not to be stopped (the TCPACK segment is to be created), each of the communication devices STA1 to STA8 of the local stations executes in step T9 creation processing of the TCPACK segment, creates in step T10 the WLANACK frame, and executes transmission processing. Thereafter, the processing proceeds to step T11.

In step T11, when the received WLANDATA frame does not include a TCPDATA segment or when although the received WLANDATA frame includes a TCPDATA segment, the TCPACK segment need not be created, each of the communication devices STA1 to STA8 of the local stations performs ordinary IP packet reception processing.

In step T12, each of the communication devices STA1 to STA8 of the local stations determines whether or not the TCPACK segment needs to be transmitted.

When the TCPACK segment needs to be transmitted, each of the communication devices STA1 to STA8 of the local stations executes in step T13 creation of the TCPACK segment, and transmission processing.

When the TCPACK segment need not be transmitted, the processing proceeds to step T14.

Further, in step T14, each of the communication devices STA1 to STA8 of the local stations executes TCP reception processing.

In this embodiment described above, when data communication is performed between the communication devices AP, and STA1 to STA8, by using the WLAN reception processing section 18, WLAN transmission processing section 19, WLANACK analysis section 20, WLANDATA analysis section 21, and TCPACK transmission stop section 22, it is possible to substitute the WLANACK frame for the TCPACK segment.

Heretofore, when TCP/IP communication is performed on the wireless LAN communication, both the WLANACK frame and TCPACK segment are transmitted from each of the communication devices STA1 to STA8 of the local stations to the communication device AP of the center station for the purpose of delivery confirmation. That is, heretofore, when TCP/IP communication is executed between the communication device (access point) of the center station and the communication device (station) of the local station in the wireless LAN communication environment, data delivery confirmation processing is executed at both the wireless LAN communication level and TCP/IP communication level. However, it is conceivable that such duplication of data delivery confirmation processing at two levels is unnecessary, and makes it difficult to reduce the amount of processing concomitant with the communication, and effectively utilize the wireless band.

Conversely, in this embodiment, when TCP/IP communication is executed in the wireless LAN communication environment, data delivery confirmation processing is executed at the wireless LAN communication level, and data delivery confirmation processing at the TCP/IP communication level is omitted, whereby reduction in the amount of processing concomitant with the communication, and effective utilization of the wireless band are realized. That is, in this embodiment, by putting together the TCPACK segment, and WLANACK segment each indicating that data has normally been transferred, it is possible to realize efficient data transfer.

In this embodiment, it is possible to perform delivery confirmation without transmitting the TCPACK segment, and deletion of the transmission processing of the TCPACK segment, and simplification of the reception processing are realized, whereby it is possible to reduce the amount of internal processing of the communication devices STA1 to STA8.

Further, in this embodiment, it is possible to reduce the CPU use and memory use in the software processing, and reduce the gate size in the hardware processing.

Furthermore, in this embodiment, there is no transmission processing of the TCPACK segment, and hence it becomes possible to use a wireless band occupied by the TCPACK transmission in the existing technique for another communication, and effectively utilize the wireless band.

Moreover, in this embodiment, the TCPACK transmission stop processing is executed in the TCP layer, and hence it is possible to omit the creation and transmission processing of an unnecessary TCPACK segment. Further, in this embodiment, the execution function of the TCPACK transmission stop processing can be added with less modification of the existing implementation contents, and hence the execution function can be easily implemented.

### Second Embodiment

In this embodiment, a modification example of the communication system 1 according to the first embodiment will be described. It should be noted that as for description associated with this embodiment, a description identical with the first embodiment described above will be omitted, and parts different from the first embodiment will mainly be described.

A communication system according to this embodiment is used in an environment in which the BlockACK function can be used, and in which a plurality of delivery confirmations to be transferred from communication devices of local stations to a communication device of a center station are put together. Specifically, in the communication system according to this embodiment, a plurality of WLANACK frames and a plurality of TCPACK segments are put together in one BlockACK frame to thereby perform delivery confirmation.

In the communication system according to this embodiment, first, wireless connection is completed (association processing is completed) between the communication device of the center station and the communication devices of the local stations. In this state, wireless LAN communication is enabled. Furthermore, the communication system forms an environment in which the BlockACK function which is one of functions of IEEE 802.11e, IEEE 802.11n, and the like can be used.

Then, the communication system establishes TCP connection for executing TCP/IP communication. When the TCP connection is established, the TCP communication is enabled.

The communication device of the center station transmits a TCPDATA segment by the normal method. In order to perform transmission by the wireless LAN communication, the TCPDATA segment is encapsulated in a wireless LAN communication frame to be transmitted.

Upon receipt of the wireless LAN communication frame including the TCPDATA segment, the communication device of the local station transmits a delivery confirmation frame for this wireless LAN communication frame. Here, in this embodiment, the BlockACK function is used, and hence delivery confirmation for a plurality of WLANDATA frames is realized by using one BlockACK frame. Furthermore, upon receipt of the wireless LAN communication frame including the TCPDATA segment, the communication device of the local station executes processing of stopping transmission of the TCPACK segment.

That is, normally, when a wireless LAN communication frame including a TCPDATA segment is received, a delivery confirmation frame for the wireless LAN communication frame is transmitted, and thereafter transmission processing of a delivery confirmation segment for the TCPDATA segment is executed in the TCP layer as the need arises. However, in this embodiment, the transmission processing of the delivery confirmation segment for the TCPDATA segment is intentionally stopped.

When the BlockACK frame which is the delivery confirmation information for the plurality of WLANDATA frames each including the TCPDATA segment is received, the communication device of the center station notifies the information indicating that delivery confirmation has been performed by the BlockACK frame to the TCP layer.

It should be noted that the description of the case where the wireless environment is worsened is identical with the case of the first embodiment.

The method of delivery confirmation according to this embodiment is also effective for a case where a SACK option is used as TCP. Further, the BlockACK frame can be applied to each of the Immediate method, Delayed method, and Compressed method.

The sequence of the conventional communication, and sequence of the communication according to this embodiment will be described below.

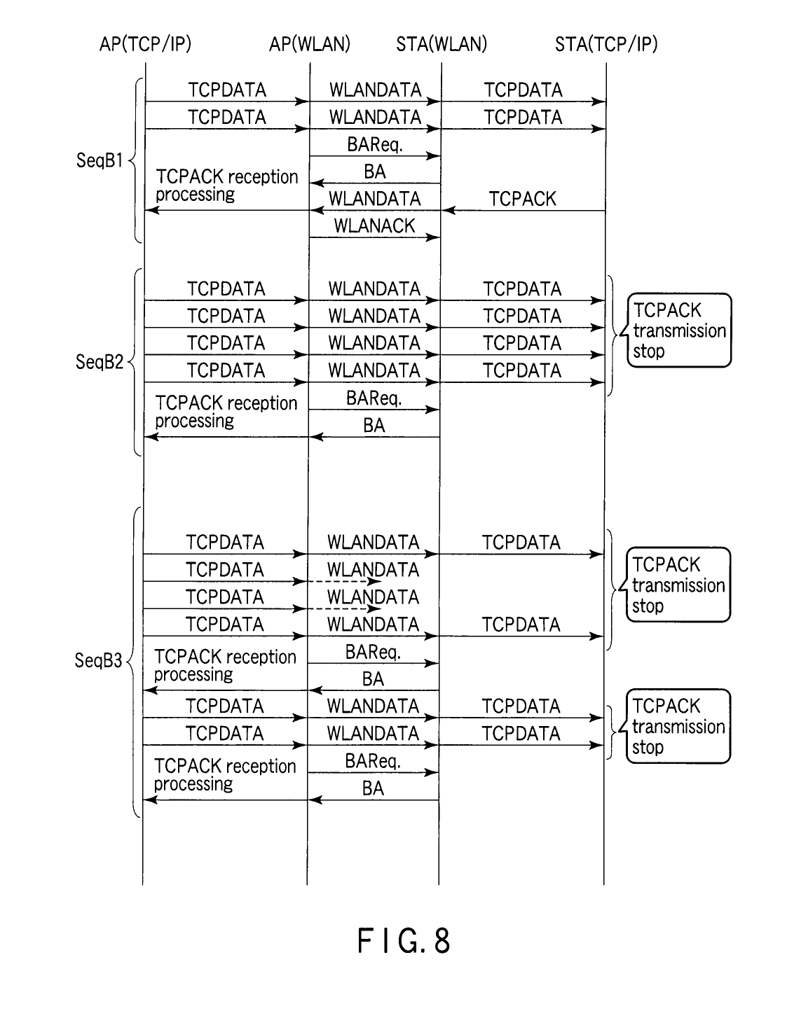

FIG. 8 is a sequence diagram (Immediate BlockACK) exemplifying communication performed in the conventional communication system, and communication performed in the communication system according to this embodiment.

In sequence SeqB1, data communication identical with the ordinary technique using the BlockACK function is performed.

First, the AP (TCP/IP) gives a TCPDATA segment to the AP (WLAN). The AP (WLAN) transmits a WLANDATA frame formed by encapsulating the TCPDATA segment to the STA (WLAN).

The STA (WLAN) receives the WLANDATA frame, and gives the TCPDATA segment included in the WLANDATA frame to the STA (TCP/IP).

The same processing is executed a plurality of times (twice in the example of FIG. 8).

After transmitting the two TCPDATA segments as described above, the AP (WLAN) transmits a BlockACK Request frame for requesting delivery confirmation to the STA (WLAN).

Upon receipt of the BlockACK Request frame, the STA (WLAN) transmits a BlockACK frame indicating that the two WLANDATA frames have normally been received to the AP (WLAN).

In this sequence SeqB1, when the two TCPDATA segments are normally received, the STA (TCP/IP) gives TCPACK segments which are delivery confirmation segments to the STA (WLAN). The STA (WLAN) transmits a WLANDATA frame formed by encapsulating the TCPACK segments to the AP (WLAN).

The AP (WLAN) receives the WLANDATA frame, and gives the TCPACK segments included in the WLANDATA frame to the AP (TCP/IP), and transmits a WLANACK frame corresponding to the received WLANDATA frame to the STA (WLAN).

In sequence SeqB2, data communication of a case where no frame loss occurs in the wireless communication in the communication system according to this embodiment is performed.

In this sequence SeqB2 in which no frame loss occurs, first, the AP (TCP/IP) gives a TCPDATA segment to the AP (WLAN). The AP (WLAN) transmits a WLANDATA frame formed by encapsulating the TCPDATA segment to the STA (WLAN).

The STA (WLAN) receives the WLANDATA frame, and gives the TCPDATA segment included in the WLANDATA frame to the STA (TCP/IP).

The same processing is executed a plurality of times (four times in the example of FIG. 8).

Although the STA (TCP/IP) receives the TCPDATA segments, the STA (TCP/IP) stops the processing of giving TCPACK segments corresponding to the TCPDATA segments to the STA (WLAN) (stoppage of TCPACK transmission).

After transmitting the four WLANDATA frames each of which includes the TCPDATA segment, the AP (WLAN) transmits a BlockACK Request frame for requesting delivery confirmation to the STA (WLAN).

Upon receipt of the BlockACK Request frame, the STA (WLAN) transmits a BlockACK frame indicating that the four WLANDATA frames have normally been received to the AP (WLAN).

The AP (WLAN) determines whether or not the BlockACK frame has been received, creates TCPACK segments corresponding to the TCPDATA segments that have been the transmission object (target) on condition that the BlockACK frame is received, and gives the created TCPACK segments to the AP (TCP/IP).

When the delivery confirmation segments (TCPACK segments) for the transmitted TCPDATA segments have normally been received, the AP (TCP/IP) shifts to the next TCPDATA segment transmission processing.

In sequence SeqB3, data communication of a case where frame loss occurs in the wireless communication in the communication system according to this embodiment is performed.

In this sequence SeqB3, first, the AP (TCP/IP) gives a TCPDATA segment to the AP (WLAN). The AP (WLAN) transmits a WLANDATA frame formed by encapsulating the TCPDATA segment to the STA (WLAN).

The same processing is executed a plurality of times (four times in the example of FIG. 8).

Here, it is assumed that although the STA (WLAN) has received some WLANDATA frames, the STA (WLAN) has not been able to receive some WLANDATA frames.

The STA (WLAN) gives TCPDATA segments included in the WLANDATA frames that could have been received to the STA (TCP/IP).

Although the STA (TCP/IP) receives the TCPDATA segments from the STA (WLAN), the STA (TCP/IP) executes TCPACK transmission stop processing of stopping the processing of giving TCPACK segments corresponding to this TCPDATA segments to the STA (WLAN).

After transmitting the four WLANDATA segments, the AP (WLAN) transmits a BlockACK Request frame for requesting delivery confirmation to the STA (WLAN).

Upon receipt of the BlockACK Request frame, the STA (WLAN) transmits a BlockACK frame which is delivery confirmation information on the WLANDATA frame level (for example, information indicating which WLANDATA frames have normally been received, and which WLANDATA frames have not been normally received) to the AP (WLAN). In FIG. 8, a case where two WLANDATA frames are normally received, and two WLANDATA frames are not received normally is exemplified.

The AP (WLAN) creates, on the basis of the received BlockACK frame, TCPACK segments corresponding to the TCPDATA segments normally received by the communication device of the local station, and gives the created TCPACK segments to the AP (TCP/IP).

Then, the AP (TCP/IP) executes frame-loss retransmission processing of giving again the TCPDATA segment that has not been normally received by the communication device of the local station to the AP (WLAN). The AP (WLAN) transmits the WLANDATA frame formed by encapsulating the retransmitted TCPDATA segment to the STA (WLAN). The STA (WLAN) gives the TCPDATA segment included in the WLANDATA frame received by the retransmission to the STA (TCP/IP). Although the STA (TCP/IP) receives the TCPDATA segment by the retransmission, the STA (TCP/IP) executes TCPACK transmission stop processing which is stopping processing of giving the TCPACK segment corresponding to the TCPDATA segment to the STA (WLAN).

The same processing is executed the times of the number of the TCPDATA segments that have not been normally received.

After retransmitting the TCPDATA segments that have not been normally received, the AP (WLAN) transmits a BlockACK Request frame for requesting delivery confirmation to the STA (WLAN).

Upon receipt of the BlockACK Request frame, the STA (WLAN) transmits a BlockACK frame indicating that the retransmitted WLANDATA frames have normally been received to the AP (WLAN).

The AP (WLAN) creates TCPACK segments corresponding to the TCPDATA segments that have been retransmitted to the communication device of the local station, and have normally been received by the communication device of the local station, and gives the created TCPACK segments to the AP (TCP/IP).

In this embodiment described above, in order to support the BlockACK frame stipulated in the IEEE 802.11e, IEEE 802.11n, and the like, functions of the WLAN reception processing section 18, WLAN transmission processing section 19, WLANACK analysis section 20, WLANDATA analysis section 21, and TCPACK transmission stop section which have been described in the first embodiment are extended so that the functions can be processed for a plurality of continuous WLAN frames, and the BlockACK frame is used in place of the TCPACK segment including a SACK option function.

As a result of this, in this embodiment, it is possible to perform delivery confirmation without transmitting the TCPACK segment, and reduce the amount of processing of the communication terminal for transmitting the TCPACK segment.

Furthermore, in this embodiment, the TCPACK segment is not transmitted, and hence, in comparison with the ordinary case, it becomes possible to use a wireless band occupied by the transmission of the TCPACK segment for another communication, and effectively utilize the wireless band.

### Third Embodiment

In this embodiment, a modification example of the first and second embodiments will be described below.

In the communication system according to each of the first and second embodiments, the communication device of the local station performs the processing of stopping the transmission of the TCPACK segment.

However, in this embodiment, in place of the transmission stop processing of the TCPACK segment in the first and second embodiment described above, a WLANDATA frame or BlockACK frame transmitted from the communication device of the local station to the communication device of the center station is extended, and the communication device of the local station puts the TCPACK segment on the WLANDATA frame or BlockACK frame, and transmits the resultant to the communication device of the center station.

That is, in this embodiment, when the transmission/reception processing of the WLANACK frame or BlockACK frame is used in place of the transmission/reception processing of the TCPACK segment, transmission is performed in a state where information of the TCPACK segment is added to the inside of the WLANACK frame or BlockACK frame.

In this embodiment described above, as compared with the case where the transmission of the TCPACK segment is stopped as in the first and second embodiments, although the frame length of the WLANDATA frame or BlockACK frame is increased by an amount corresponding to the TCPACK segment to be added to the WLANDATA frame or BlockACK frame, as compared with the ordinary case where one TCPACK segment is transmitted as a frame, the amount of data to be communicated, and wireless band can be reduced, and the network resources can be effectively utilized.

### Fourth Embodiment

In this embodiment, a modification example of the communication system in each of the first to third embodiments will be described. It should be noted that although a modification example of the second embodiment will be described below, the same modification can also be made with respect to the first or third embodiment.

Although in the second embodiment described above, the transmission stop processing of the TCPACK segment is executed, in this embodiment, processing of temporarily stopping the transmission of the TCPACK segment is executed in place of the transmission stop processing of the TCPACK segment, and when the WLANDATA frame is not normally received, the TCPACK is transmitted from the communication device of the local station to the communication device of the center station.

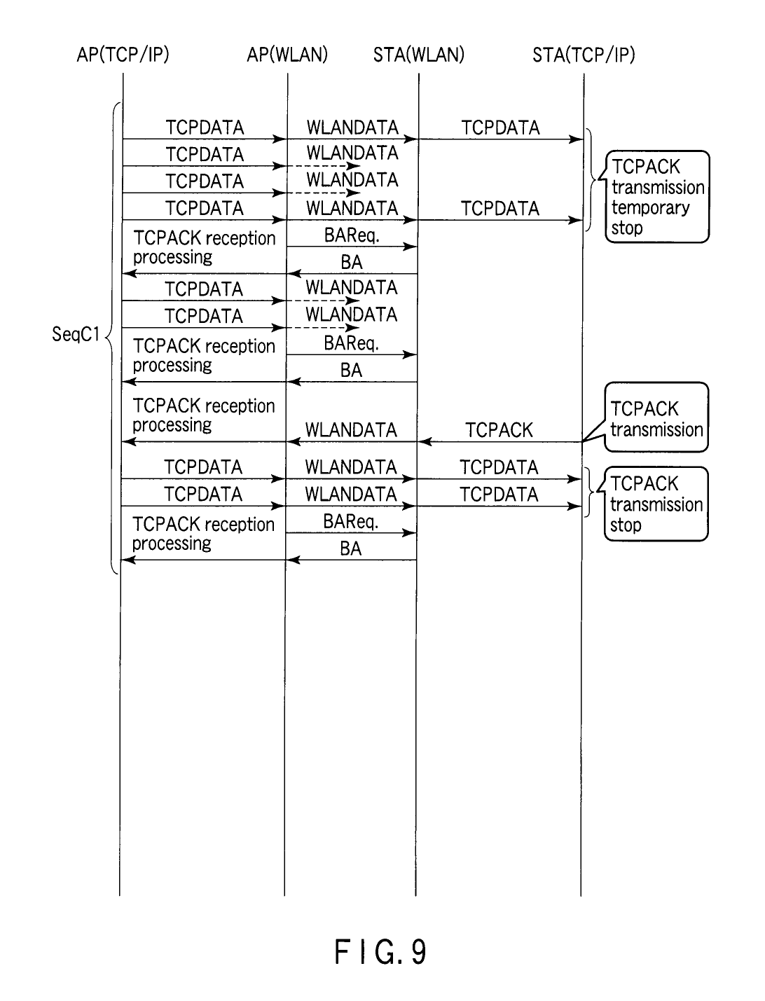

FIG. 9 is a sequence diagram (BlockACK) showing an example of communication performed in the communication system according to this embodiment.

In sequence SeqC1 shown in FIG. 9, a WLANDATA frame formed by encapsulating the TCPDATA segment is transmitted from the communication device of the center station to the communication device of the local station. It is assumed here that some WLANDATA frames (two in the example of FIG. 9) among a plurality of WLANDATA frames (four in the example of FIG. 9) are not normally received by the communication device of the local station, and some WLANDATA frames (two in the example of FIG. 9) are normally received by the communication device of the local station.

In the communication device of the local station, transmissions of TCPACK segments corresponding to the TCPDATA segments encapsulated in the received WLANDATA frames are temporarily stopped.

Further, a BlockACK Request frame is transmitted from the communication device of the center station to the communication device of the local station. Then, the communication device of the local station transmits a BlockACK frame to the communication device of the center station as the delivery confirmation information for the WLANDATA frames that have been normally received.

The communication device of the center station executes reception processing of the TCPACK segments (creation or the like of the TCPACK segments) corresponding to the TCPDATA segments that have been normally received by the communication device of the local station on the basis of the BlockACK frame.

Furthermore, the communication device of the center station executes retransmission processing of the TCPDATA segments that have not been normally received by the communication device of the local station.

When the communication device of the local station normally receives the TCPDATA segments encapsulated in the retransmitted WLANDATA frames as a result of the retransmission, the communication device of the local station executes transmission temporary stop processing of the TCPACK segments. It should be noted that in the example of FIG. 9, it is assumed that the communication device of the local station has not been able to normally receive the WLANDATA frames even by the retransmission.

A BlockACK Request frame is transmitted from the communication device of the center station to the communication device of the local station. Then, the communication device of the local station transmits a BlockACK frame to the communication device of the center device as delivery confirmation information. When the retransmitted TCPDATA segments have normally been received by the communication device of the local station on the basis of the BlockACK frame, the communication device of the center station executes reception processing of the TCPACK segments corresponding to the TCPDATA segments normally received by the retransmission.

Even when the retransmission processing has been executed a predetermined number of times, if the communication device of the local station have not been able to normally receive the TCPDATA segment encapsulated in the WLANDATA frame, the communication system terminates the retransmission processing at the WLAN frame level. In this case, in the TCP processing of the communication device of the center station, transmission of the Window size of the TCP is enabled. However, when the size exceeds the Window size, the TCP processing is brought into a TCPACK segment-waiting state, i.e., a state where no transmission is enabled.

Thus, in this embodiment, when the retransmission processing at the WLAN frame level is terminated in the communication system, the communication device of the local station generates a TCPACK segment after an elapse of a certain time, and transmits a WLANDATA frame formed by encapsulating the TCPACK segment to the communication device of the center station.

The communication device of the center station receives the WLANDATA frame in which the TCPACK segment is encapsulated, and it becomes possible to transmit the size exceeding the Window size by the reception of the TCPACK segment.

Thereafter, the same processing is repeated.

In this embodiment described above, even when retransmission is performed, if frame loss occurs, a WLANDATA frame formed by encapsulating a TCPACK segment is transmitted from the communication device of the local station to the communication device of the center station. As a result of this, the problem of the TCPACK segment-waiting of the size exceeding the Window size of the TCP can be solved.

In this embodiment, in, for example, streaming delivery of contents from the communication device of the center station to the communication device of the local station, it is possible prevent the delivery from being interrupted.

### Fifth Embodiment

In this embodiment, a modification example of the communication system according to the fourth embodiment will be described.

In the fourth embodiment described above, the case where frame loss occurs in the WLAN frame transmitted from the communication device of the center station to the communication device of the local station is described. However, in this embodiment, a case where frame loss occurs in a BlockACK frame transmitted from the communication device of the local station to the communication device of the center station will be described.

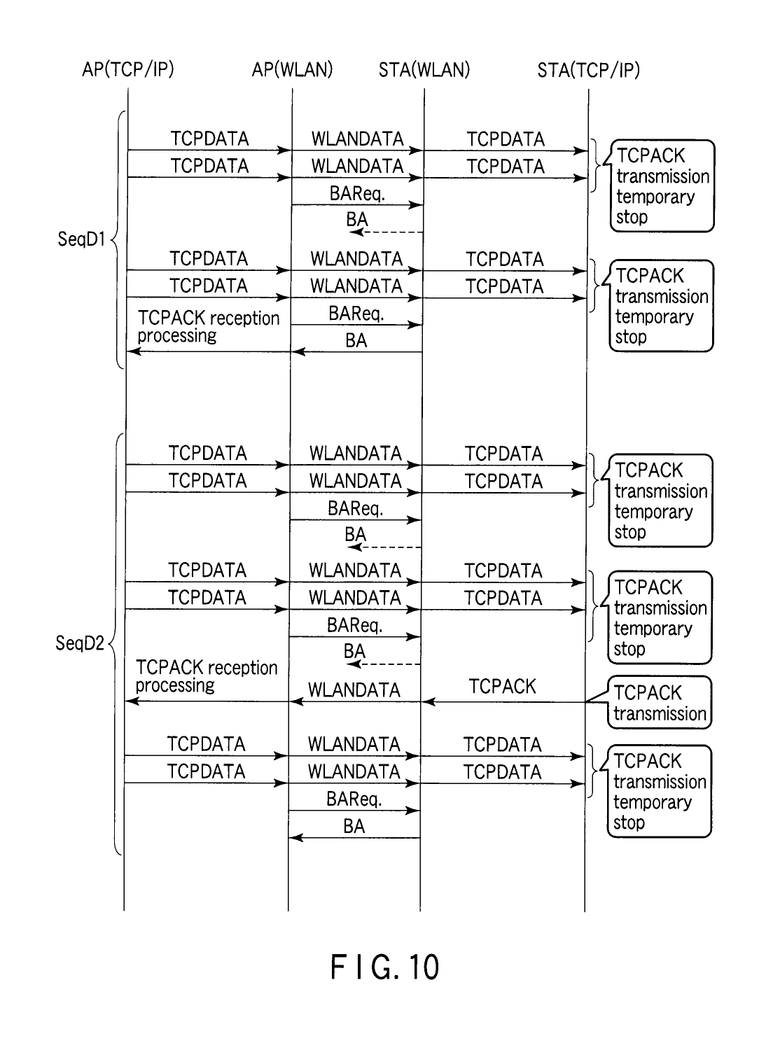

FIG. 10 is a sequence diagram (BlockACK) showing an example of communication performed in a communication system according to this embodiment.

In sequence SeqD1, a WLANDATA frame formed by encapsulating a TCPDATA segment is transmitted from a communication device of a center station to a communication device of a local station. A plurality of WLANDATA frames (two in the example of FIG. 10) are normally received by the communication device of the local station. When the TCPDATA segments encapsulated in the received WLANDATA frames are received, the communication device of the local station executes processing of temporarily stopping the transmission of the TCPOACK segments.

Then, the communication device of the center station transmits a BlockACK Request frame to the communication device of the local station. Then, the communication device of the local station transmits a BlockACK frame which is delivery confirmation information to the communication device of the center station.

However, the BlockACK frame transmitted from the communication device of the local station is not received by the communication device of the center station.

Thus, the communication device of the center station retransmits the wLANDATA frames formed by encapsulating the TCPDATA segments to the communication device of the local station, and further transmits a BlockACK Request frame corresponding to the retransmission to the communication device of the local station.

The communication device of the local station receives the BlockACK Request frame corresponding to the retransmission. Further, the communication device of the local station executes processing of transmitting a BlockACK frame corresponding to the received BlockACK Request frame to the communication device of the center station, and processing of temporarily stopping transmission of the TCPACK segments.

In sequence SeqD2, a WLANDATA frame formed by encapsulating a TCPDATA segment is transmitted from the communication device of the center station to the communication device of the local station. A plurality of WLANDATA frames (two in the example of FIG. 10) are normally received by the communication device of the local station. When the TCPDATA segments encapsulated in the received WLANDATA frames are received, the communication device of the local station executes processing of temporarily stopping transmission of the TCPACK segments.

Then, the communication device of the center station transmits a BlockACK Request frame to the communication device of the local station. Then, the communication device of the local station transmits a BlockACK frame which is delivery confirmation information to the communication device of the center station.

However, the BlockACK frame transmitted from the communication device of the local station is not received by the communication device of the center station.

Thus, the communication device of the center station retransmits a WLANDATA frames formed by encapsulating a TCPDATA segments to the communication device of the local station. However, in this retransmission too, frame loss occurs in the BlockACK frame transmitted from the communication device of the local station.

When the retransmission processing is executed even a predetermined number of times, if the communication device of the center station cannot normally receive the BlockACK frame, the communication system terminates the retransmission processing on the WLAN frame level.

In this case, the communication device of the local station generates a TCPACK segment after an elapse of a certain time, and transmits a WLANDATA frame formed by encapsulating the TCPACK segment to the communication device of the center station.

The communication device of the center station receives the WLANDATA frame in which the TCPACK segment is encapsulated, and it becomes possible, by the reception of the TCPACK segment, to execute transmission processing of the next TCPACK segment.

In this embodiment, the same effect as the fourth embodiment can be obtained and, in, for example, streaming delivery of contents from the communication device of the center station to the communication device of the local station, it is possible prevent the delivery from being interrupted.

### Sixth Embodiment

In this embodiment, a modification example of the first to fifth embodiments will be described.

In the first to fifth embodiment, in the TCP/IP software processing section, the TCPACK transmission stop processing (including processing of temporarily stopping transmission of the TCPACK segment) is executed.

Conversely, in this embodiment, in a WLAN software processing section, the TCPACK transmission stop processing is executed.

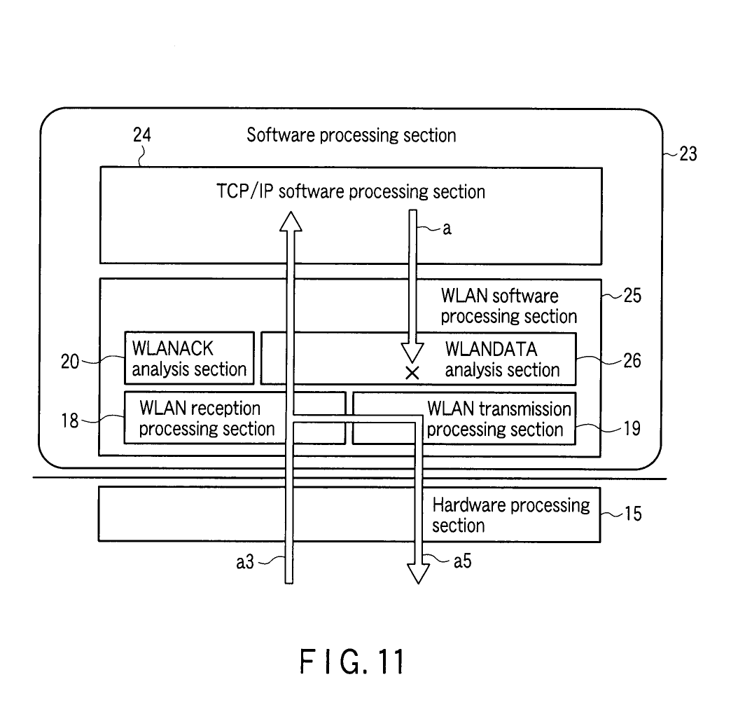

FIG. 11 is a block diagram showing an example of software of a communication device of a local station according to this embodiment.

In this embodiment, a software processing section 23 is provided with a TCP/IP software processing section 24, and WLAN software processing section 25.

For example, a WLANDATA analysis section 26 of the WLAN software processing section 25 is provided with a TCPACK transmission stop section 22 of FIG. 4.

The TCP/IP software processing section 24 creates a TCPACK segment corresponding to a received TCPDATA segment as in the normal case, and gives the created TCPACK segment to the WLAN software processing section 25. However, transmission of the TCPACK segment is stopped by, for example, the WLANDATA analysis section 26 of the WLAN layer.

In the communication device of the local station according to this embodiment described above, the TCPACK transmission stop processing is executed in the WLAN layer. As a result of this, the same effect as the first to fifth embodiments can be obtained. Furthermore, in this embodiment, only the ordinary WLAN part has to be changed, and the TCP/IP software processing 24 can be used in the same state as the ordinary case.

What is claimed is:

1. A wireless communication device of a local station performing TCP/IP communication in an environment in which wireless LAN communication conforming to a IEEE 802.11 standard is performed comprising:
a reception processing unit for receiving a WLANDATA frame formed by encapsulating a TCPDATA segment from a wireless communication device of a center station;
a transmission processing unit for transmitting a WLANACK frame which is delivery confirmation information corresponding to the WLANDATA frame to the wireless communication device of the local station; and
a TCPACK transmission stop unit for executing processing of stopping transmission of a TCPACK segment which is delivery confirmation information corresponding to the TCPDATA segment when the WLANACK frame is transmitted to the wireless communication device of the center station.

2. The wireless communication device of the local station according to claim 1, wherein
the transmission processing unit transmits the WLANACK frame in which the TCPACK segment corresponding to the normally received TCPDATA segment is encapsulated.

3. The wireless communication device of the local station according to claim 1, further comprising:
a WLAN software processing unit including the reception processing unit, the transmission processing unit, and an analysis unit; and
a TCP/IP software processing unit including the TCPACK transmission stop unit, wherein
the analysis unit receives the WLANDATA frame from the reception processing unit, and delivers information indicating that the WLANACK frame corresponding to the WLANDATA frame has already been transmitted to the wireless communication device of the center station to the TCP/IP software processing unit, and
the TCPACK transmission stop unit determines whether or not the information has already been received from the analysis unit, and executes, when the information has already been received from the analysis unit, processing of stopping transmission of the TCPACK segment.

4. The wireless communication device of the local station according to claim 1, further comprising:
a WLAN software processing unit including the reception processing unit, the transmission processing unit, an analysis unit, and the TCPACK transmission stop unit; and
a TCP/IP software processing unit, wherein
the analysis unit receives the WLANDATA frame from the reception processing unit, and delivers information indicating that the WLANACK frame corresponding to the WLANDATA frame has already been transmitted to the wireless communication device of the center station to the TCPACK transmission stop unit, and
when the information is received, the TCPACK transmission stop unit executes processing of stopping transmission of the TCPACK segment.

5. The wireless communication device of the local station according to claim 1, wherein
the processing of stopping transmission of the TCPACK segment includes processing of stopping creation of the TCPACK segment.

6. The wireless communication device of the local station according to claim 1, wherein
the TCPACK transmission stop unit executes processing of temporarily stopping transmission of the TCPACK segment corresponding to the TCPDATA segment, and
the transmission processing unit transmits a WLANDATA frame formed by encapsulating a plurality of TCPACK segments which have temporarily been stopped to the wireless communication device of the center station.

7. The wireless communication device of the center station corresponding to the wireless communication device of the local station according to claim 1, comprising:
a transmission unit for transmitting the WLANDATA frame to the wireless communication device of the local station;
a reception unit for receiving the WLANACK frame from the wireless communication device of the local station; and
a center station analysis unit for determining, when the WLANACK frame is received, that a TCPACK segment which is delivery confirmation information for the TCPDATA segment has been received.

8. The wireless communication device of the center station according to claim 7, further comprising:
a TCP/IP unit; and
a WLAN unit including the transmission unit, reception unit, and center station analysis unit, wherein
the TCP/IP unit creates the TCPDATA segment,
the transmission unit creates the WLANDATA frame on the basis of the TCPDATA segment created by the TCP/IP unit, and transmits the created WLANDATA frame to the wireless communication device of the local station,
the reception unit receives the WLANACK frame from the wireless communication device of the local station, and
the center station analysis unit creates a TCPACK segment indicating delivery confirmation of the TCPDATA segment corresponding to the WLANACK frame, and delivers the TCPACK segment to the TCP/IP unit.

9. A wireless communication device of a local station performing TCP/IP communication in an environment in which wireless LAN communication conforming to a IEEE 802.11e or IEEE 802.11n standard is performed comprising:
a reception processing unit for receiving a BlockACK Request frame for requesting a BlockACK frame which is delivery confirmation information corresponding to a plurality of WLANDATA frames each of which is formed by encapsulating a TCPDATA segment from a wireless communication device of a center station;
a transmission processing unit for transmitting, when the BlockACK Request frame is received, the BlockACK frame to the wireless communication device of the center station; and
a TCPACK transmission stop unit for executing processing of stopping transmission of a TCPACK segment which is delivery confirmation information corresponding to a TCPDATA segment encapsulated in a normally received WLANDATA frame among the plurality of WLANDATA frames when the BlockACK frame is transmitted to the wireless communication device of the center station.

10. The wireless communication device of the local station according to claim 9, wherein
the transmission processing unit transmits the WLANACK frame in which the TCPACK segment corresponding to the normally received TCPDATA segment is encapsulated.

11. The wireless communication device of the local station according to claim 9, wherein
the TCPACK transmission stop unit executes processing of temporarily stopping transmission of the TCPACK segment corresponding to the TCPDATA segment, and
the transmission processing unit transmits a WLANDATA frame formed by encapsulating a plurality of TCPACK segments which have temporarily been stopped to the wireless communication device of the center station.

12. The wireless communication device of the center station corresponding to the wireless communication device of the local station according to claim 9, comprising:
a transmission unit for transmitting, to the wireless communication device of the local station, a plurality of WLANDATA frames each of which is formed by encapsulating a TCPDATA segment, and transmitting thereafter a BlockACK Request frame for requesting a BlockACK frame which is delivery confirmation information corresponding to the plurality of WLANDATA frames;
a reception unit for receiving the BlockACK frame corresponding to the BlockACK Request frame from the communication device of the local station; and
a center station analysis unit for determining that “a TCPACK segment which is delivery confirmation information corresponding to a TCPDATA segment encapsulated in a WLANDATA frame being normally received by the communication device of the local station among the plurality of WLANDATA frames” is received on the basis of the BlockACK frame.

13. The wireless communication device of the center according to claim 12, further comprising:
a TCP/IP unit; and
a WLAN unit including the transmission unit, reception unit, and center station analysis unit, wherein
the center station analysis unit creates the TCPACK segment corresponding to the TCPDATA segment encapsulated in the normally received WLANDATA frame on the basis of the BlockACK frame, and gives the TCPACK segment to the TCP/IP unit.
